(19) United States
(12) Patent Application Publication
(10) Pub. No.: US 2026/0328655 A1
(43) Pub. Date: Oct. 22, 2026

(54) SAMPLE COLLECTION DEVICE

(71) Applicant: SHIMADZU CORPORATION, Kyoto (JP)

(72) Inventor: Kosuke NAKAJIMA, Kyoto-shi (JP)

(73) Assignee: SHIMADZU CORPORATION, Kyoto (JP)

(21) Appl. No.: 19/642,234

(22) Filed: Apr. 8, 2026

(30) Foreign Application Priority Data
Apr. 18, 2025 (JP) 2025-068722

(51) Int. Cl. G01N 1/14; B01L 9/06

(52) U.S. Cl. CPC G01N 1/14; B01L 9/06

(57) ABSTRACT

A sample collection device comprising: a rack that holds a container having an opening in a state where the opening faces upward; a needle; a needle movement mechanism that moves the needle in horizontal and vertical directions; a suction and discharge mechanism that sucks and discharges liquid via the needle; and a liquid scattering means that scatters the liquid discharged from the tip of the needle by the suction and discharge mechanism into the container by vibrating the needle in a state where the tip of the needle is positioned inside the container by the needle movement mechanism.

### TECHNICAL FIELD

The present invention relates to a sample collection device.

### Background Art

A sample collection device generally includes a tubular needle, a pump for sucking and discharging liquid via the needle, and a needle movement mechanism for moving the needle in horizontal and vertical directions (see, for example, Patent Document 1).

### Prior Art Documents

### Patent Document

Patent Document 1 Japanese Unexamined Patent Application Publication No. 2024-009515

### SUMMARY OF INVENTION

### Technical Problem

The sample collection device as described above is mainly used for the purpose of collecting a liquid sample in a sample container and injecting it into an analyzer or another container. At this time, a part of the sample may adhere to the inner wall surface of the sample container. However, in conventional sample collection devices, since the part of the sample cannot be collected by the needle, the recovery rate of the sample decreases.

Further, the sample collection device as described above may be used to add a solvent to a dry sample for dissolution. In such a case, a liquid sample is dried in a sample container in advance, and a predetermined solvent is added to the sample container by the needle of the sample collection device. Then, a sample solution obtained by adding the solvent to the dry sample is collected from the sample container by the needle and injected into an analyzer or another container. However, even in such a case, a part of the dry sample may adhere to the inner wall surface of the sample container. In that case, in conventional sample collection devices, the part of the sample cannot be dissolved in the solvent, and the recovery rate of the sample decreases.

The decrease in recovery rate due to the adhesion of the sample to the inner wall surface of the container as described above is often negligible, but it may be a problem particularly when handling rare samples.

The present invention has been made in view of the above points, and an object thereof is to provide a sample collection device capable of preventing a decrease in the recovery rate of a sample from a container even when the sample adheres to the inner wall surface of the container.

### Means for Solving the Problem

A sample collection device according to the present invention for solving the above problem comprises:
a rack that holds a container having an opening in a state where the opening faces upward;
a needle;
a needle movement mechanism that moves the needle in horizontal and vertical directions;
a suction and discharge mechanism that sucks and discharges liquid via the needle; and
a liquid scattering means that scatters the liquid discharged from the tip of the needle by the suction and discharge mechanism into the container by vibrating the needle in a state where the tip of the needle is positioned inside the container by the needle movement mechanism.

### Effects of the Invention

According to the sample collection device according to the present invention having the configuration as described above, the sample adhering to the inner wall surface of the container can be washed away and collected at the bottom of the container by the liquid scattered by the liquid scattering means. Therefore, almost the entire amount of the sample can be easily collected by the needle, and a decrease in the sample recovery rate can be prevented.

### BRIEF DESCRIPTION OF THE DRAWINGS

FIG. 1 is a schematic configuration diagram of a sample collection device according to an embodiment of the present invention.

FIG. 2 is a block diagram showing a main configuration of a drive system and a control unit of the sample collection device.

FIG. 3 is a flowchart showing an example of an operation of the sample collection device.

FIG. 4 is a schematic view showing a cleaning process of an inner wall surface of a sample container according to the present embodiment.

FIG. 5 is a flowchart showing another example of the operation of the sample collection device.

FIG. 6 is a schematic configuration diagram of a sample collection device according to another embodiment of the present invention.

FIG. 7 is a block diagram showing a main configuration of a drive system and a control unit of the sample collection device.

FIG. 8 is a photograph showing a test conducted to confirm the effects of the present invention.

### DESCRIPTION OF EMBODIMENTS

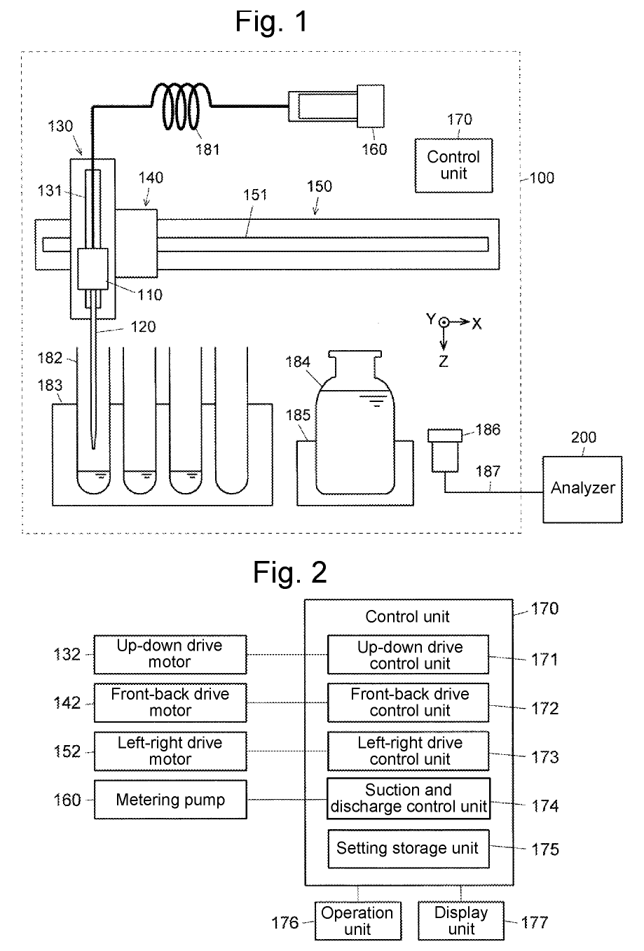

Hereinafter, embodiments for carrying out the present invention will be described with reference to the drawings. FIG. 1 is a schematic configuration diagram of a sample collection device 100 according to the present embodiment. FIG. 2 is a block diagram showing a main configuration of a drive system and a control unit 170 of the sample collection device 100 according to the present embodiment. For convenience of explanation, front, back, left, right, up, and down are defined below, with the arrow direction of the X-axis in FIG. 1 being the right side, the arrow direction of the Y-axis being the front side, and the arrow direction of the Z-axis being the downward direction.

The sample collection device 100 includes a head unit 110, a needle 120 attached to the head unit 110 with its tip pointing downward, an up-down movement mechanism 130 that moves the head unit 110 in the vertical direction, a front-back movement mechanism 140 that moves the head unit 110 and the up-down movement mechanism 130 in the front-back direction, a left-right movement mechanism 150 that moves the head unit 110, the up-down movement mechanism 130, and the front-back movement mechanism 140 in the left-right direction, a metering pump 160 connected to the base end side of the needle 120 via a flexible connecting pipe 181, and a control unit 170.

The up-down movement mechanism 130 includes an up-down rail 131 extending in the vertical direction and an up-down drive motor 132 (corresponding to a motor in the present invention) that moves the head unit 110 along the up-down rail 131. The front-back movement mechanism 140 includes a front-back rail (not shown) extending in the front-back direction and a front-back drive motor 142 that moves the up-down movement mechanism 130 (and the head unit 110) along the front-back rail. The left-right movement mechanism 150 includes a left-right rail 151 extending in the left-right direction and a left-right drive motor 152 that moves the front-back movement mechanism 140 (as well as the up-down movement mechanism 130 and the head unit 110) along the left-right rail 151. These motors 132, 142, and 152 can be composed of, for example, stepping motors, but are not limited thereto.

In the present embodiment, the up-down movement mechanism 130, the front-back movement mechanism 140, and the left-right movement mechanism 150 correspond to the needle movement mechanism in the present invention, and the metering pump 160 corresponds to the suction and discharge mechanism in the present invention. As the metering pump 160, for example, a syringe pump can be used, but it is not limited thereto.

The sample collection device 100 is further provided with a sample container rack 183 (corresponding to a rack in the present invention) capable of accommodating a plurality of sample containers 182 (corresponding to a container in the present invention), a solvent container rack 185 in which one or a plurality of solvent containers 184 are accommodated, and an injection port 186 connected to an injection pipe 187 which is a pipe leading to a predetermined analyzer 200. In this sample collection device 100, the tip of the needle 120 can be inserted into any of the sample containers 182, the solvent containers 184, or the injection port 186 by moving the head unit 110 by the up-down movement mechanism 130, the front-back movement mechanism 140, and the left-right movement mechanism 150. Note that the type of the analyzer 200 is not particularly limited, and may be any device such as a chromatograph such as a liquid chromatograph, a gas chromatograph, or a supercritical fluid chromatograph, or a mass spectrometer.

The control unit 170 includes, as functional blocks, an up-down drive control unit 171 that controls the up-down drive motor 132, a front-back drive control unit 172 that controls the front-back drive motor 142, a left-right drive control unit 173 that controls the left-right drive motor 152, and a suction and discharge control unit 174 that controls the metering pump 160. The control unit 170 further includes a setting storage unit 175 that stores various setting items. The control unit 170 is actually a computer including a CPU, a memory, and a large-capacity storage device such as a hard disk drive (HDD) or a solid state drive (SSD), and the functions of the functional blocks are realized by the CPU of the computer executing a predetermined program pre-installed in the computer. Further, the setting storage unit 175 is realized by a large-capacity storage device provided in the computer. The computer constituting the control unit 170 may be a dedicated computer, a general-purpose computer such as a personal computer, or a combination of both. To the control unit 170, an operation unit 176 including a pointing device such as a keyboard and a mouse, and a display unit 177 including a liquid crystal display, an organic EL display, or the like are connected.

In the present embodiment, the up-down drive control unit 171 and the suction and discharge control unit 174 cooperate to function as the liquid scattering means in the present invention.

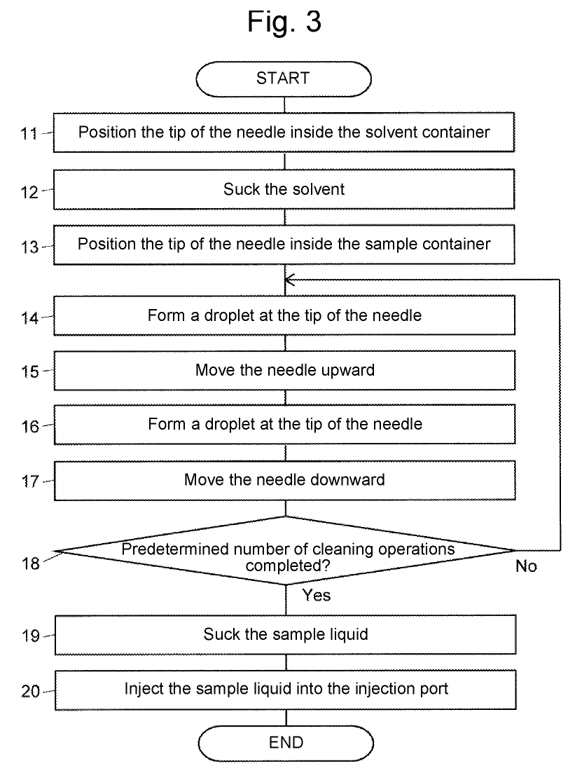

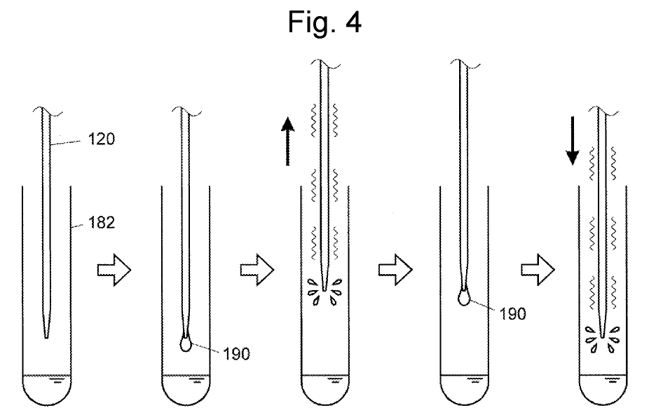

The sample collection device 100 according to the present embodiment has a function of cleaning the inner wall surface of the sample container 182 before collecting the sample in the sample container 182. Hereinafter, an example of the operation of the sample collection device 100 according to the present embodiment will be described with reference to the flowchart of FIG. 3 and the schematic diagram of FIG. 4. Here, it is assumed that a sample container 182 containing a liquid sample in advance is set in the sample container rack 183, and a solvent container 184 containing a predetermined solvent (for example, water) is set in the solvent container rack 185. Further, it is assumed that the position of the sample container 182 as a sample collection target on the sample container rack 183 and the position of the solvent container 184 containing the solvent used for cleaning on the solvent container rack 185 are input in advance by the user's operation via the operation unit 176 and stored in the setting storage unit 175.

When the user performs a predetermined operation on the operation unit 176 to instruct collection of a sample, first, the up-down drive control unit 171, the front-back drive control unit 172, and the left-right drive control unit 173 control the up-down drive motor 132, the front-back drive motor 142, and the left-right drive motor 152, respectively, to move the head unit 110 from a predetermined initial position, so that the tip of the needle 120 is positioned in a pre-designated solvent container 184 (step 11). Subsequently, the suction and discharge control unit 174 controls the metering pump 160 to suck a predetermined amount of the solvent in the solvent container 184 from the tip of the needle 120 (step 12). The suction amount of the solvent at this time is set in advance by the user or the manufacturer of the sample collection device 100 and stored in the setting storage unit 175.

Thereafter, the up-down drive control unit 171, the front-back drive control unit 172, and the left-right drive control unit 173 control the up-down drive motor 132, the front-back drive motor 142, and the left-right drive motor 152, respectively, to move the head unit 110, so that the tip of the needle 120 is positioned at a predetermined height in a pre-designated sample container 182 (step 13). The state at this time is shown at the left end of FIG. 4. The height position of the tip of the needle 120 at this time is set in advance by the user or the manufacturer of the sample collection device 100 and stored in the setting storage unit 175.

Next, the suction and discharge control unit 174 controls the metering pump 160 to discharge a small amount of the solvent sucked in step 12 from the tip of the needle 120. At that time, by setting the liquid amount of the solvent to be discharged to an amount that does not fall from the tip of the needle 120, a droplet 190 is formed at the tip of the needle 120 (step 14). The state at this time is shown second from the left in FIG. 4. The discharge amount of the solvent at this time is determined in advance by the user based on the viscosity of the solvent, the tip shape of the needle 120, or the like, and stored in the setting storage unit 175.

With the droplet 190 formed at the tip of the needle 120 as described above, the up-down drive control unit 171 operates the up-down drive motor 132 to move the needle 120 upward by a predetermined distance (step 15). At that time, the vibration generated in the up-down drive motor 132 is transmitted to the needle 120 and the needle 120 vibrates, whereby the droplet 190 is scattered from the tip of the needle 120 to the surroundings. The state at this time is shown third from the left in FIG. 4.

Thereafter, in the same manner as in step 14, a droplet 190 is formed again at the tip of the needle 120 (step 16; state shown fourth from the left in FIG. 4). Then, by lowering the needle 120 by a predetermined distance in that state, the droplet 190 is scattered from the tip of the needle 120 as in step 15 (step 17; state shown at the right end of FIG. 4). The moving distance of the needle 120 in the vertical direction in step 15 and step 17 is set in advance by the user or the manufacturer of the sample collection device 100 and stored in the setting storage unit 175.

Subsequently, the control unit 170 determines whether or not the operations of steps 14 to 17 (hereinafter referred to as a cleaning operation) have been performed a predetermined number of times (step 18). The number of executions of the cleaning operation is also set in advance by the user or the manufacturer of the sample collection device 100 and stored in the setting storage unit 175. If it is determined in step 18 that the cleaning operation has not been performed the predetermined number of times, the process returns to step 14, and step 14 to step 18 are repeatedly performed. By repeatedly performing the cleaning operation in this way, the solvent droplets 190 scattered from the tip of the needle 120 adhere to the inner wall surface of the sample container 182 one after another, and the droplets 190 flow down to the bottom of the sample container 182 by their own weight, and the inner wall surface of the sample container 182 is washed away by the solvent in the process.

Thereafter, at a point in time when it is determined in step 18 that the cleaning operation has been completed the predetermined number of times, the up-down drive control unit 171 controls the up-down drive motor 132 to lower the tip of the needle 120 to near the inner bottom of the sample container 182, and then the suction and discharge control unit 174 controls the metering pump 160, so that the liquid remaining at the bottom of the sample container 182, that is, a mixture of the sample and the solvent (hereinafter referred to as a sample liquid), is sucked in a predetermined amount (for example, the entire amount) from the tip of the needle 120 (step 19).

Next, the up-down drive control unit 171, the front-back drive control unit 172, and the left-right drive control unit 173 control the up-down drive motor 132, the front-back drive motor 142, and the left-right drive motor 152, respectively, to move the head unit 110, so that the tip of the needle 120 is inserted into the injection port 186. Further, the suction and discharge control unit 174 controls the metering pump 160 to discharge a predetermined amount (for example, the entire amount) of the sample liquid from the tip of the needle 120 and inject it into the injection port 186 (step 20). The sample liquid injected into the injection port 186 is introduced into the analyzer 200 via the injection pipe 187 and subjected to analysis by the analyzer 200.

Although the sample liquid is injected into the injection port 186 in step 20 here, the sample liquid may be injected into a container (for example, an empty sample container 182 mounted on the sample container rack 183) different from the sample container 182 in which the sample liquid was contained. In this case, the injection destination of the sample liquid in step 20 is set in advance by the user and stored in the setting storage unit 175.

As described above, according to the sample collection device 100 according to the present embodiment, the droplet 190 can be scattered from the tip of the needle 120, and the inner wall surface of the sample container 182 can be cleaned with the droplet. Thereby, even when a part of the sample accommodated in the sample container 182 adheres to the inner wall surface of the sample container 182, the sample can be washed away toward the bottom of the sample container 182 and collected at the bottom of the sample container 182, and the total amount of the sample can be easily collected by the needle 120.

In the above embodiment, a case where a liquid sample accommodated in the sample container 182 is injected into the analyzer 200 or another container has been described as an example. However, even in a case where a sample in a dry state (for example, a liquid sample dried in the sample container 182) is accommodated in the sample container 182 in advance, the inner wall surface of the sample container 182 can be cleaned with a solvent and the sample liquid accumulated at the bottom of the sample container 182 can be sucked and injected into the analyzer 200 or another container by the same procedure as that shown in the flowchart of FIG. 3.

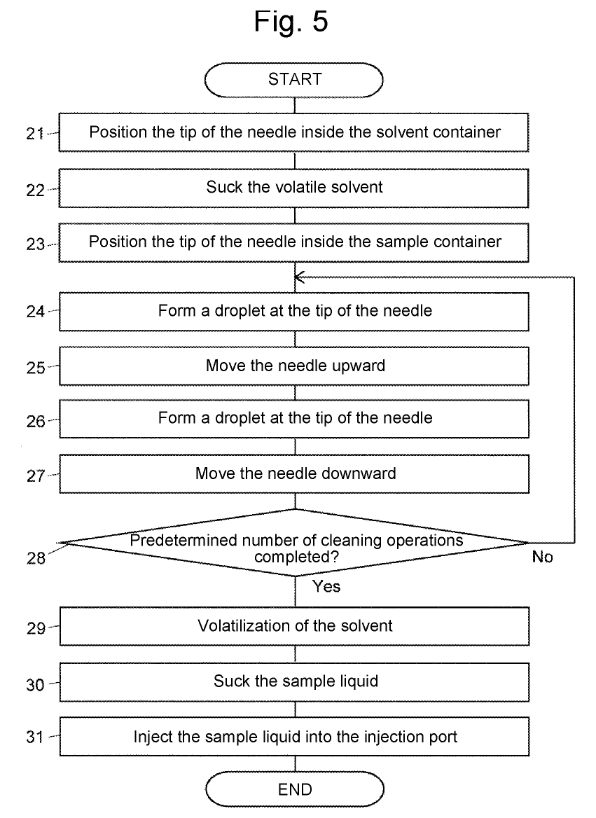

Another operation example of the sample collection device 100 according to the present embodiment is shown in the flowchart of FIG. 5. In this example, it is assumed that a sample container 182 containing a liquid sample in advance is set in the sample container rack 183, and a solvent container 184 containing a volatile solvent is set in the solvent container rack 185. Here, the volatile solvent means a substance having a boiling point in the range of 50 to 95 °C and being in a liquid state at room temperature (20 °C ± 15 °C), or a liquid containing 10% or more of such a substance. Examples of the substance having a boiling point in the range of 50 to 95 °C and being in a liquid state at room temperature (20 °C ± 15 °C) include volatile organic compounds such as acetonitrile, methanol, ethanol, acetone, toluene, isopropanol, hexane, butanol, cyclohexane, ethylene glycol, benzene, chloroform, acetaldehyde, triethylamine, phenol, naphthalene, formaldehyde, tetrahydrofuran, or ethyl acetate.

In this operation example, first, a predetermined amount of the volatile solvent is sucked from the solvent container 184 (steps 21 and 22), and then the cleaning operation of the sample container 182 using the volatile solvent is repeatedly executed a predetermined number of times (steps 23 to 28). The operations of the sample collection device 100 in steps 21 and 22 are the same as steps 11 and 12 in the flowchart of FIG. 3, and the operations of the sample collection device 100 in steps 23 to 28 are the same as steps 13 to 18 in the flowchart of FIG. 3, so detailed descriptions thereof are omitted here.

Thereafter, at the point in time when the predetermined number of cleaning operations are completed (that is, at the point in time of Yes in step 28), a step of volatilizing the volatile solvent in the sample container 182 is executed (step 29). In this step, the volatile solvent may be naturally volatilized by leaving the sample container 182 to stand for a predetermined time, or the volatilization of the volatile liquid may be promoted by heating the sample container 182 or blowing gas into the sample container 182.

In the present operation example, at the time when the predetermined number of cleaning operations are completed (that is, the time when Yes in step 28), a mixed liquid of the liquid sample previously stored in the sample container 182 and the volatile solvent is in a state of being accumulated at the bottom of the sample container 182. Then, in subsequent step 29, by volatilizing the volatile solvent, only the liquid sample previously stored in the sample container 182 remains accumulated at the bottom of the sample container 182. Therefore, after completing step 29, the entire amount of the liquid remaining at the bottom of the sample container 182 (that is, the liquid sample) is sucked by the needle 120 (step 30), and the entire amount of the sucked liquid is injected into the injection port 186 by the needle 120 (step 31).

As described above, in the present operation example, the inner wall surface of the sample container 182 is cleaned with the volatile solvent to collect the sample adhering to the inner wall surface at the bottom of the sample container 182, and the volatile solvent used for cleaning can be volatilized and removed. Therefore, the total amount of the sample in the sample container 182 can be injected into the analyzer 200 without any residue, and the sample can be prevented from being diluted by the cleaning operation.

In the above embodiment, the up-down drive motor 132 continuously moves the needle 120 over a predetermined distance, and the needle 120 is vibrated by the vibration generated by the up-down drive motor 132 at that time. However, the present invention is not limited to this, and the up-down drive motor 132 may be a stepping motor, and the needle 120 may be vibrated by rotating the stepping motor step by step (i.e., intermittently) by a predetermined step angle.

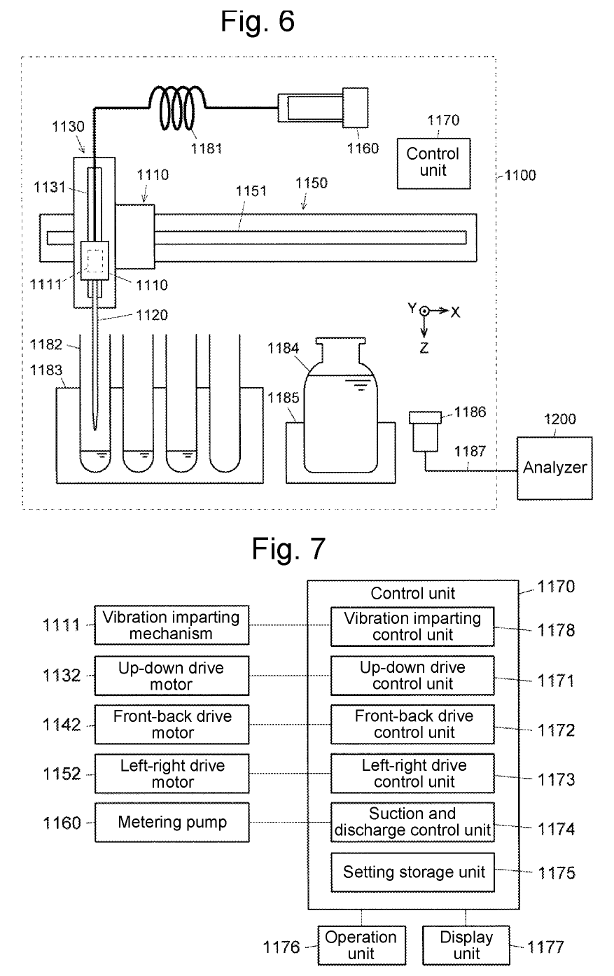

Further, the sample collection device according to the present invention may be provided with a mechanism for vibrating the needle 120 separately from the up-down drive motor 132. Such an embodiment will be described with reference to FIGS. 6 and 7. In these figures, components that are the same as or correspond to those shown in FIGS. 1 and 2 are given the same last three digits, and the description thereof will be omitted as appropriate. In the present embodiment, a vibration imparting mechanism 1111 is provided in the head unit 1110. The vibration imparting mechanism 1111 can include, for example, a motor or the like, but is not limited thereto. Furthermore, in the present embodiment, the control unit 1170 is provided with a vibration imparting control unit 1178 that controls the vibration imparting mechanism 1111. According to such a configuration, in a state where a droplet made of a solvent as described above is formed at the tip of the needle 1120, the vibration imparting mechanism 1111 vibrates the needle 1120 under the control of the vibration imparting control unit 1178, whereby the inner wall surface of the sample container 1182 can be cleaned by scattering the droplet. In this case, the vibration imparting mechanism 1111, the vibration imparting control unit 1178, and the suction and discharge mechanism 1174 cooperate to function as the liquid scattering means in the present invention.

While the embodiments for carrying out the present invention have been described above with specific examples, the present invention is not limited to the above embodiments, and appropriate changes are allowed within the scope of the gist of the present invention. For example, in the above embodiment, a small amount of solvent is first discharged from the tip of the needles 120, 1120 to form a droplet 190, and then the needle 120, 1120 is vibrated in a state where the discharge of the solvent is stopped to scatter the droplet 190. Alternatively, the solvent may be scattered by discharging the solvent from the tip of the needles 120, 1120 while vibrating the needle 120.

Further, in the above embodiment, suction and discharge of liquid by the needles 120, 1120 are performed by driving the metering pumps 160, 1160. However, the present invention is not limited to this. For example, a syringe having a needle and a piston may be provided in the head units 110, 1110, and the piston may be driven by a piston drive mechanism including a motor or the like to perform suction and discharge of liquid by the needle.

In addition, the sample collection device 100, 1100 according to the present invention may be a device that introduces a sample liquid into a flow path leading to the analyzer 200, 1200 (that is, an autosampler) as in the above embodiment, or it may be a so-called liquid handler. The liquid handler is a device used by being attached to a liquid chromatograph which is the analyzer 200, 1200, and has both a function as an autosampler for introducing a sample liquid into a flow path leading to a column of the liquid chromatograph and a function as a fraction collector for collecting an eluate from the column.

### Examples

Hereinafter, examples performed to confirm the effects of the present invention will be described. In this example, verification was performed using crystal violet (hereinafter referred to as a dye), which has high visibility, instead of a sample.

Specifically, first, an appropriate amount of the dye was dissolved in 10 mL of acetonitrile in a test tube, and the dye solution was completely dried in the test tube by blowing nitrogen onto the obtained solution (dye solution). Next, in the sample collection device having the configuration as shown in FIG. 1, the test tube to which the dry dye was adhered was set in the sample container rack 183, and about 100 μL of solvent (water) was sucked from the solvent container 184 by the needle 120. Subsequently, the tip of the needle 120 was entered into the test tube, and the tip of the needle 120 was positioned at a height of 3 cm from the bottom of the test tube (the position of the needle 120 at this time is referred to as a first position). Next, a droplet made of the solvent was formed at the tip of the needle 120 by discharging 3 μL of the solvent from the needle 120. Then, the needle 120 was raised by 1 cm from the first position, and the droplet was scattered in the test tube by the vibration of the up-down drive motor 132 at that time (the position of the needle 120 after raising is referred to as a second position). Next, at the second position, 3 μL of the solvent was again discharged from the needle 120 to form a droplet at the tip of the needle 120, and then the needle was lowered to the first position, and the droplet was scattered in the test tube by the vibration of the up-down drive motor 132 at that time. The inner wall surface of the test tube was cleaned by performing the formation of the droplet at the tip of the needle 120 and the scattering of the droplet by the movement (upward or downward) of the needle 120 as described above 30 times in 3 minutes.

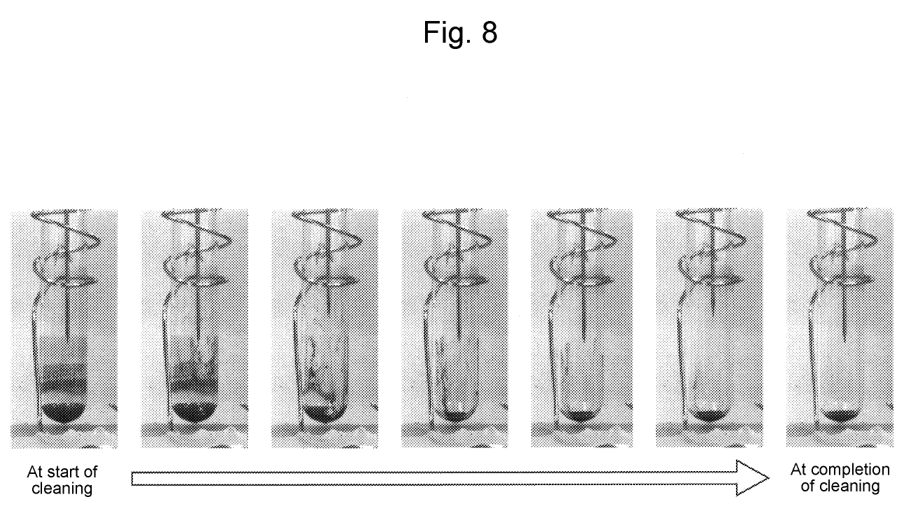

FIG. 8 shows a photograph of the test tube during the cleaning. The figure shows photographs of the test tube taken in the course of the cleaning, arranged in chronological order from left to right. The leftmost photograph in the figure shows the test tube at the start of cleaning. In the state of this photograph, the dye in the test tube is completely dry, and the dye in the dry state adheres to the inner wall surface over a predetermined height from the bottom of the test tube. On the other hand, the rightmost photograph in the figure shows the test tube at the completion of cleaning. In the figure, the dye is removed from the inner wall surface of the test tube, and a solution containing the dye and the solvent is accumulated at the bottom of the test tube. From this, it was confirmed that the sample adhering to the inner wall surface of the container can be washed away to the bottom of the container by the method of the present invention.

### Aspects

It is obvious to those skilled in the art that the exemplary embodiments described above are specific examples of the following aspects.
(Item 1) A sample collection device according to one aspect of the present invention comprises:
   a rack that holds a container having an opening in a state where the opening faces upward;
   a needle;
   a needle movement mechanism that moves the needle in horizontal and vertical directions;
   a suction and discharge mechanism that sucks and discharges liquid via the needle;
   and a liquid scattering means that scatters the liquid discharged from the tip of the needle by the suction and discharge mechanism into the container by vibrating the needle in a state where the tip of the needle is positioned inside the container by the needle movement mechanism.
(Item 2) The sample collection device according to Item 2 is the sample collection device according to Item 1,
   wherein the needle movement mechanism has a motor for moving the needle in the vertical direction, and
   the liquid scattering means moves the needle in the vertical direction by the motor in a state where the tip of the needle is positioned inside the container by the needle movement mechanism, and vibrates the needle by transmitting vibration generated in the motor at that time to the needle.
(Item 3) The sample collection device according to Item 3 is the sample collection device according to Item 1 or 2,
   wherein the liquid scattering means forms a droplet made of the liquid at the tip of the needle by the suction and discharge mechanism in a state where the tip of the needle is positioned inside the container by the needle movement mechanism, and then vibrates the needle.
(Item 4) The sample collection device according to Item 4 is the sample collection device according to Item 1 or 2, wherein
   the liquid scattering means discharges the liquid from the tip of the needle while vibrating the needle in a state where the tip of the needle is positioned inside the container by the needle movement mechanism.
(Item 5) A sample injection method according to Item 5 is:
   a method for injecting a sample into a predetermined analyzer using a sample collection device having:
      a rack that holds a container having an opening in a state where the opening faces upward;
      a needle;
      a needle movement mechanism that moves the needle in horizontal and vertical directions;
      a suction and discharge mechanism that sucks and discharges liquid via the needle; and a liquid scattering means that scatters the liquid discharged from the tip of the needle by the suction and discharge mechanism into the container by vibrating the needle in a state where the tip of the needle is positioned inside the container by the needle movement mechanism,
      the method comprising:
         scattering a volatile solvent into the container by the liquid scattering means in a state where the container containing a liquid sample is held in the rack; and
         after evaporating the volatile solvent in the container, sucking the total amount of the sample in the container with the needle and injecting it into the predetermined analyzer.

### DESCRIPTION OF REFERENCE NUMERALS

100... Sample collection device
110... Head unit
120... Needle
130... Up-down movement mechanism
132... Up-down drive motor
140... Front-back movement mechanism
142... Front-back drive motor
150... Left-right movement mechanism
152... Left-right drive motor
160... Metering pump
170... Control unit
171... Up-down drive control unit
172... Front-back drive control unit
173... Left-right drive control unit
174... Suction and discharge control unit
182... Sample container
183... Sample container rack
184... Solvent container
186... Injection port
190... Droplet
200... Analyzer

1. A sample collection device comprising:
a rack that holds a container having an opening in a state where the opening faces upward;
a needle;
a needle movement mechanism that moves the needle in horizontal and vertical directions;
a suction and discharge mechanism that sucks and discharges liquid via the needle; and
a liquid scattering means that scatters the liquid discharged from the tip of the needle by the suction and discharge mechanism into the container by vibrating the needle in a state where the tip of the needle is positioned inside the container by the needle movement mechanism.

2. The sample collection device according to claim 1, wherein
the needle movement mechanism has a motor for moving the needle in the vertical direction, and
the liquid scattering means moves the needle in the vertical direction by the motor in a state where the tip of the needle is positioned inside the container by the needle movement mechanism, and vibrates the needle by transmitting vibration generated in the motor at that time to the needle.

3. The sample collection device according to claim 1, wherein
the liquid scattering means forms a droplet made of the liquid at the tip of the needle by the suction and discharge mechanism in a state where the tip of the needle is positioned inside the container by the needle movement mechanism, and then vibrates the needle.

4. The sample collection device according to claim 1, wherein
the liquid scattering means discharges the liquid from the tip of the needle while vibrating the needle in a state where the tip of the needle is positioned inside the container by the needle movement mechanism.

5. A sample injection method for injecting a sample into a predetermined analyzer using a sample collection device having:
a rack that holds a container having an opening in a state where the opening faces upward;
a needle;
a needle movement mechanism that moves the needle in horizontal and vertical directions;
a suction and discharge mechanism that sucks and discharges liquid via the needle; and
a liquid scattering means that scatters the liquid discharged from the tip of the needle by the suction and discharge mechanism into the container by vibrating the needle in a state where the tip of the needle is positioned inside the container by the needle movement mechanism,
the method comprising:
scattering a volatile solvent into the container by the liquid scattering means in a state where the container containing a liquid sample is held in the rack; and
after evaporating the volatile solvent in the container, sucking the total amount of the sample in the container with the needle and injecting it into the predetermined analyzer.

6. The sample injection method according to claim 5, wherein
the needle movement mechanism has a motor for moving the needle in the vertical direction, and

7. The sample injection method according to claim 5, wherein

8. The sample injection method according to claim 5, wherein
the liquid scattering means discharges the liquid from the tip of the needle while vibrating the needle in a state where the tip of the needle is positioned inside the container by the needle movement mechanism.
